(19) United States
(12) Patent Application Publication
(10) Pub. No.: US 2022/0302505 A1
(43) Pub. Date: Sep. 22, 2022

(54) METHOD FOR PRODUCING BATTERY MEMBER AND DEVICE FOR PRODUCING BATTERY MEMBER

(71) Applicant: HONDA MOTOR CO., LTD., Tokyo (JP)

(72) Inventors: Yui KINOSHITA, Saitama (JP); Satonori IURA, Saitama (JP); Shuga IKEDA, Saitama (JP); Masaki KUNIGAMI, Saitama (JP)

(21) Appl. No.: 17/680,317

(22) Filed: Feb. 25, 2022

(30) Foreign Application Priority Data
Mar. 22, 2021 (JP) 2021-046771

(51) Int. Cl. H01M 10/0585; H01M 10/0525

(52) U.S. Cl. CPC H01M 10/0585; H01M 10/0525

(57) ABSTRACT

Provided are a method for producing a battery member and a device for producing a battery member that make it possible to integrate layers of the battery member by way of a roll press, and make it possible to achieve favorable performance of the battery member. A method is for producing a battery member having a positive electrode sheet including at least a positive electrode current collector and a negative electrode sheet including at least a negative electrode current collector, at least one of the positive electrode sheet and the negative electrode sheet having an electrolyte layer laminated thereon.

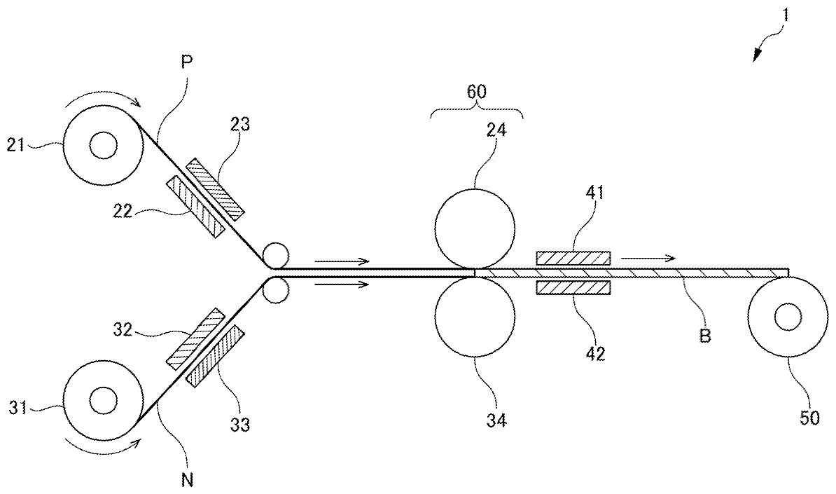

This application is based on and claims the benefit of priority from Japanese Patent Application No. 2021-046771, filed on 22 Mar. 2021, the content of which is incorporated herein by reference.

### BACKGROUND OF THE INVENTION

### Field of the Invention

The present invention relates to a method for producing a battery member and a device for producing a battery member.

### Related Art

A known method for producing a battery member includes a step of integrating a positive electrode sheet including at least a positive electrode current collector and a negative electrode sheet including at least a negative electrode current collector with an electrolyte layer laminated on at least one of the positive electrode sheet and the negative electrode sheet, through pressure molding (see, for example, Patent Document 1).
Patent Document 1: PCT International Publication No. WO2011/064842

### SUMMARY OF THE INVENTION

Patent Document 1 discloses, as examples of the pressing method, hot flat pressing, hot roll pressing, and the like. Compared to the flat pressing, the roll pressing is a method enabling serial production, in turn enabling mass production at a lower cost. On the other hand, it is preferable that the positive electrode sheet, the negative electrode sheet, and the electrolyte layer are heated and pressed in order to achieve densification and resistance reduction in the battery. However, compared to the production method employing a flat press as pressing means, the production method employing a roll press as pressing means involves a problem in that the layers of the battery member cannot be sufficiently heated due to a shorter pressing time. In addition, there is a problem in that heating and pressing the layers of a battery member at the same temperature do not result in sufficient densification of the layers and sufficient resistance reduction in the battery.

The present invention has been made in view of the foregoing, and an object of the present invention is to provide a method for producing a battery member and a device for producing a battery member that make it possible to integrate layers of the battery member by way of a roll press, and make it possible to achieve favorable performance of the battery member.

A first aspect of the present invention is directed to a method for producing a battery member having a positive electrode sheet including at least a positive electrode current collector and a negative electrode sheet including at least a negative electrode current collector, at least one of the positive electrode sheet and the negative electrode sheet having an electrolyte layer laminated thereon. The method includes successively: a preliminary heating step including heating the positive electrode sheet and the negative electrode sheet to a predetermined temperature; and a roll pressing step including integrating the positive electrode sheet with the negative electrode sheet. In the roll pressing step, a roll pressing temperature for the positive electrode sheet and a roll pressing temperature for the negative electrode sheet are set to different temperature ranges.

The first aspect of the present invention provides the method for producing a battery member, the method making it possible to integrate the layers of a battery member by way of a roll press, and making it possible to achieve favorable performance of the battery member.

A second aspect is an embodiment of the first aspect. The method according to the second aspect further includes, after the roll pressing step, a stepwise cooling step including cooling in a stepwise manner the positive electrode sheet and the negative electrode that have been integrated with each other.

The second aspect of the present invention makes it possible to inhibit the positive electrode sheet and the negative electrode sheet that have been subjected to the roll pressing and integrated with each other from being rapidly cooled.

A third aspect is an embodiment of the first or second aspect. According to the third aspect, in the preliminary heating step, a preliminary heating temperature for the positive electrode sheet and a preliminary heating temperature for the negative electrode sheet are set to different temperature ranges.

The third aspect of the present invention makes it possible to heat the layers constituting the battery member at further preferable temperatures, whereby performance of the battery member can be improved.

A fourth aspect of the present invention is directed to a device for producing a battery member having a positive electrode sheet including at least a positive electrode current collector and a negative electrode sheet including at least a negative electrode current collector, at least one of the positive electrode sheet and the negative electrode sheet having an electrolyte layer laminated thereon. The device includes: a first heater that heats the positive electrode sheet; a second heater that heats the negative electrode sheet; and a roll press that is disposed after the first heater and the second heater, and integrates the positive electrode sheet with the negative electrode sheet. In the roll press, a heating temperature for the positive electrode sheet and a heating temperature for the negative electrode sheet are set to different temperature ranges.

The fourth aspect of the present invention provides the device for producing a battery member, the device making it possible to integrate the layers of the battery member by way of the roll press, and making it possible to achieve favorable performance of the battery member.

A fifth aspect is an embodiment of the fourth aspect. The device according to the fifth aspect further includes a heat retainer disposed after the roll press.

The fifth aspect of the present invention makes it possible to inhibit the positive electrode sheet and the negative electrode sheet that have been subjected to the roll pressing and integrated with each other from being rapidly cooled.

A sixth aspect is an embodiment of the fourth or fifth aspect. In the device according to the sixth aspect, a temperature of the first heater and a temperature of the second heater are set to different temperature ranges.

The sixth aspect of the present invention makes it possible to heat the layers constituting the battery member at further preferable temperatures, whereby performance of the battery member can be improved.

### BRIEF DESCRIPTION OF THE DRAWINGS

FIGURE is a schematic diagram illustrating a device for producing a battery member according to an embodiment of the present invention.

### DETAILED DESCRIPTION OF THE INVENTION

### <Method for Producing Battery Member>

A method according to an embodiment is for producing a battery member having a positive electrode sheet including at least a positive electrode current collector and a negative electrode sheet including at least a negative electrode current collector. At least one of the positive electrode sheet and the negative electrode sheet has an electrolyte layer laminated thereon. A battery member as a laminate of electrodes can be produced by integrating the positive electrode sheet and the negative electrode sheet described above.

The method for producing the battery member according to the present embodiment includes successively: a preliminary heating step of heating the positive electrode sheet and the negative electrode sheet to a predetermined temperature; and a roll pressing step of integrating the positive electrode sheet with the negative electrode sheet. The method may further include, after the roll pressing step, a stepwise cooling step of cooling in a stepwise manner the positive electrode sheet and the negative electrode sheet integrated with each other.

### (Preliminary Heating Step)

The preliminary heating step includes heating the positive electrode sheet and the negative electrode sheet to the predetermined temperature. The preliminary heating step makes it possible to shorten a heating time even in the case of using the roll press as means for pressing the battery member, whereby favorable performance of the battery member can be achieved. In the preliminary heating step, it is preferable to heat the positive electrode sheet and the negative electrode sheet in different temperature ranges. For example, the temperature range for heating the positive electrode sheet may be from 100° C. to 150° C., and the temperature range for heating the negative electrode sheet having the electrolyte layer laminated thereon may be from 135° C. to 200° C.

### (Roll Pressing Step)

The roll pressing step includes heating and pressing the positive electrode sheet and the negative electrode sheet, thereby integrating the sheets with each other. In the roll pressing step, the positive electrode sheet and the negative electrode sheet, which are processing targets, are passed through a gap between a pair of heating rolls facing each other, whereby the sheets are subjected to heating and pressing processes. In the roll pressing step, it is preferable to heat the positive electrode sheet and the negative electrode sheet at different roll pressing temperatures, similarly to the preliminary heating step. For example, the temperature range for heating the positive electrode sheet may be from 100° C. to 150° C., and the temperature range for heating the negative electrode sheet having the electrolyte layer laminated thereon may be from 135° C. to 200° C. As a result, the positive electrode sheet and the negative electrode sheet can be integrated with each other, and densification and resistance reduction of the positive electrode sheet, the negative electrode sheet, and the electrolyte layer laminated on the negative electrode sheet can be achieved.

### (Stepwise Cooling Step)

The stepwise cooling step includes cooling in a stepwise manner the positive electrode sheet and the negative electrode sheet that have been integrated with each other by way of the roll pressing step. The stepwise cooling step is a step alternative to the conventional cooling step that includes cooling, at room temperature, the positive electrode sheet and the negative electrode sheet integrated with each. The stepwise cooling step includes allowing the positive electrode sheet and the negative electrode sheet integrated with each other to be gradually cooled, while heating the sheets at a predetermined temperature. The stepwise cooling step can inhibit the positive electrode sheet and the negative electrode sheet integrated with each other from being rapidly cooled, thereby making it possible to inhibit detachment and deformation of the positive electrode sheet and the negative electrode sheet integrated with each other. In the stepwise cooling step, any method for heating the positive electrode sheet and the negative electrode sheet integrated with other may be employed. A known method may be employed. The predetermined temperature for heating the positive electrode sheet and the negative electrode sheet integrated with each other is not limited either, and is only required to be within a temperature range lower than the temperature range of the roll pressing step. Alternatively, a plurality of temperature ranges may be set along a direction in which the positive electrode sheet and the negative electrode sheet that have been integrated with other in the roll pressing step are moved, such that temperatures of the plurality of temperature ranges gradually decrease toward a later stage.

### [Battery Member]

The battery member according to the present embodiment has the positive electrode sheet including at least a positive electrode current collector and the negative electrode sheet including at least a negative electrode current collector. The battery member according to the present embodiment is for use as, for example, an electrode laminate in a lithium-ion solid secondary battery.

### (Positive Electrode Sheet and Negative Electrode Sheet)

The positive electrode sheet includes at least a positive electrode current collector, and is obtained, for example, by laminating a positive electrode material mixture layer on the positive electrode current collector. The negative electrode sheet includes at least a negative electrode current collector, and is obtained, for example, by laminating a negative electrode material mixture layer on the negative electrode current collector. For example, the positive electrode sheet and the negative electrode sheet are each sheet-shaped material that is fed from a wound body formed in a roll-to-roll manner. At least one of the positive electrode sheet and the negative electrode sheet has an electrolyte layer laminated thereon.

Densification and resistance reduction of the positive electrode sheet, the negative electrode sheet, and the electrolyte layer are preferable for improvement of the performance of the battery member. For this reason, it is effective to integrate the positive electrode sheet and the negative electrode sheet with each other while subjecting the sheets not only to pressing but also to heating at a predetermined temperature. As described above, the optimal temperature ranges for the heating the positive electrode sheet, the negative electrode sheet, and the electrolyte layer are different from one another. A positive electrode active material and the like constituting the positive electrode sheet, a negative electrode active material and the like constituting the negative electrode sheet, and an electrolyte forming the electrolyte layer are materials different from one another. These materials all may experience material modification due to thermal decomposition and/or chemical reaction when heated excessively. On the other hand, the temperature ranges in which the thermal decomposition and/or the chemical reaction are likely to be caused are different from one material to another. Therefore, the positive electrode sheet, the negative electrode sheet, and the electrolyte layer each have a respective preferable temperature range in which the material is softened, the densification proceeds, but thermal decomposition and chemical reaction are not caused.

### (Positive Electrode Current Collector)

The positive electrode current collector is not limited to any particular current collector. For example, a known current collector usable for a positive electrode of a solid battery can be applied. Examples of the positive electrode current collector include a metal foil such as a stainless steel (SUS) foil and an aluminum (Al) foil.

### (Positive Electrode Material Mixture Layer)

A substance constituting the positive electrode material mixture layer is not limited to any particular material, as long as the positive electrode active material is contained. For example, a substance known as a positive electrode active material for a solid battery can be applied. The composition thereof is not limited either, and a solid electrolyte, a conductive aid, a binder, and the like may be contained in addition to the positive electrode active material.

Examples of the positive electrode active material include: a transition metal chalcogenide such as titanium disulfide, molybdenum disulfide, and niobium selenide; a transition metal oxide such as lithium nickelate (LiNiO₂), lithium manganate (LiMnO₂, LiMn₂O₄), lithium cobaltite (LiCoO₂), and lithium nickel cobalt manganese composite oxide (NCM); and the like. Among these, lithium nickel cobalt manganese composite oxide (NCM) is preferably used.

### (Negative Electrode Current Collector)

The negative electrode current collector is not limited to any particular current collector. For example, a known current collector usable for a negative electrode of a solid battery can be applied. Examples of the negative electrode current collector include a metal foil such as a stainless steel (SUS) foil, a copper (Cu) foil.

### (Negative Electrode Material Mixture Layer)

A substance constituting the negative electrode material mixture layer is not limited as long as the negative electrode active material is contained. For example, a substance known as a negative electrode active material for a solid battery can be applied. The composition thereof is not limited either, and a solid electrolyte, a conductive aid, a binder, and the like may be contained in addition to the negative electrode active material.

Examples of the negative electrode active material include: metal lithium; a lithium alloy; a metal oxide; a metal sulfide; a metal nitride; Si; SiO; a carbon material such as graphite, hard carbon, and soft carbon; and the like. Among these, the carbon material is preferably used.

### (Electrolyte Layer)

The electrolyte layer is laminated on one surface or both surfaces of at least one of the positive electrode sheet and the negative electrode sheet. The positive electrode sheet and the negative electrode sheet are integrated with each other such that the electrolyte layer is interposed between the positive electrode current collector and the negative electrode current collector. The electrolyte layer is a layer containing an electrolyte material such as a solid electrolyte material. Charge transfer between the positive electrode active material and the negative electrode active material is allowed via the solid electrolyte material. Alternatively, the electrolyte layer may be a layer obtained by filling a base material with a known liquid electrolyte or a known gel electrolyte for use in a liquid-system battery.

The solid electrolyte material is not limited to any particular material. Examples thereof include a sulfide solid electrolyte material, an oxide solid electrolyte material, a nitride solid electrolyte material, a halide solid electrolyte material, and the like.

### <Device for Producing Battery Member>

FIGURE illustrates a device 1 for producing a battery member according to the present embodiment. As illustrated in FIGURE, the device 1 includes a first heater 22, a second heater 32, a roll press 60 having a pair of rolls 24 and 34, heat retainers 41 and 42, and a sheet winder 50. The device 1 is a roll-to-roll production device configured to integrate a positive electrode sheet. P fed from a winding body 21 with a negative electrode sheet N fed from a winding body 31, by heating and pressing the sheets by means of the roll press 60, and is configured to collect the integrated sheets by means of the sheet winder 50. Note that the foregoing is a non-limiting example. The device 1 may be a device configured to integrate the positive electrode sheet P and the negative electrode sheet N that are conveyed by a conveying device such as a belt conveyor.

### (First Heater)

The first heater 22 is disposed before the roll press 60 and preliminarily heats the positive electrode sheet P to be heated and pressed by the roll press 60. Providing the first heater 22 makes it possible to heat the positive electrode sheet P to a temperature preferable for achieving densification and resistance reduction, even in a case in which the positive electrode sheet P is heated by the roll press 60 for a short time. The first heater 22 may be set to, for example, a temperature range from 100° C. to 150° C. The first heater 22 is not limited to any particular heater. A known heating device, such as a ceramic heater, a sheathed heater, a halogen lamp heater, and an induction heater, can be applied. The first heater 22 only needs to include one first heater or a plurality of first heaters disposed at a position facing one surface of the positive electrode sheet P. To prevent heat dissipation, a first heat retainer 23 may be provided at a position facing the other surface of the positive electrode sheet P. The first heat retainer 23 may be set to any temperature range. For example, the heat retainer 23 may be set to a temperature range equal to or higher than room temperature and equal to or lower than the temperature range of the first heater 22. A device similar to the first heater 22 may be used as the first heat retainer 23.

### (Second Heater)

The second heater 32 is disposed before the roll press 60 and preliminarily heats the negative electrode sheet N to be heated and pressed by the roll press 60. Providing the second heater 32 makes it possible to heat the negative electrode sheet N to a temperature preferable for achieving densification and resistance reduction, even in a case in which the negative electrode sheet N is heated by the roll press 60 for a short time. The second heater 32 may be set to, for example, a temperature range from 135° C. to 200° C. The second heater 32 may have a configuration similar to that of the first heater 22, except for the set temperature range. The second heater 32 is disposed at a position facing one surface of the negative electrode sheet N, and a second heat retainer 33 may be disposed at a position facing the other surface of the negative electrode sheet N. The second heat retainer 33 may be set to a temperature range equal to or higher than room temperature and equal to and lower than the temperature range of the second heat retainer 32. The second heat retainer 33 may have a configuration similar to that of the first heat retainer 23.

### (Roll Press)

The roll press 60 has the pair of rolls 24 and 34. The roll press 60 is disposed after the first heater 22 and the second heater 32, and integrates the positive electrode sheet P with the negative electrode sheet N by heating and pressing them. The roll 24 and the roll 34 are arranged, for example, to vertically face each other with a gap interposed therebetween, and heat and press the positive electrode sheet P and the negative electrode sheet N that are passed through the gap. The roll press 60 has a heating device(s) (not illustrated) that heats the roll 24 and the roll 34. The heating device(s) may heat the roll 24 and the roll 34 from inside, from outside, or from inside and outside. The heating device(s) is not limited to any particular device, and a known heating device as listed as the examples of the first heater 22 may be used.

In the roll pressing 60, a heating temperature for the positive electrode sheet P and a heating temperature for the negative electrode sheet N are set to different temperature ranges. This configuration makes it possible to heat the positive electrode sheet P and the negative electrode sheet N at respective appropriate roll pressing temperatures and to integrate the sheets with each other, whereby the performance of the battery member B can be improved. The roll 24 that comes into contact with and heats the positive electrode sheet P may be set to, for example, a temperature range from 100° C. to 150° C. Likewise, the roll 34 that comes into contact with and heats the negative electrode sheet N may be set to, for example, a temperature range from 135° C. to 200° C.

### (Heat Retainers)

The heat retainers 41 and 42 are disposed after the roll press 60, and have a function of conserving heat of the battery member B that has been integrated by the roll press 60. The heat retainers 41 and 42 allow the battery member B, which has been heated by the roll press 60, to be cooled in a stepwise manner to room temperature. This configuration inhibits the battery member B from being rapidly cooled. The heat retainers 41 and 42 are not limited to any particular configuration except that the temperature ranges of the heat retainers 41 and 42 are set to be lower than the temperature ranges of the rolls 24 and 34 of the roll press 60. Known heating devices can be used as the heat retainers 41 and 42. In the present embodiment, the pair of heat retainers 41 and 42 are disposed to face both surfaces of the battery member B; however, one heat retainer may be disposed to face one surface of the battery member B. Alternatively, a plurality of pairs of heat retainers as described above may be disposed such that temperature ranges thereof gradually decrease toward a later stage.

### (Sheet Winder)

The sheet winder 50 is a device that collects the battery member B conveyed in a roll-to-roll manner, by winding the battery member B into a roll shape. The sheet winder 50 may be provided with a plurality of conveying rollers that rotatably hold the battery member B, the positive electrode sheet P, and the negative electrode sheet N. As the sheet winder 50 described above, a known winding device having a drive source may be used. The sheet winder 50 is an example of means for conveying the positive electrode sheet P, the negative electrode sheet N, and the battery member B. A known conveying device such as a belt conveyor may be used instead of the sheet winder 50.

The above-described embodiment is not intended to limit the present invention, and modifications and the like made without deviating from the spirit of the present invention are also encompassed in the scope of the present invention.

### EXPLANATION OF REFERENCE NUMERALS

1: Device for producing battery member
22: First heater
32: Second heater
41, 42: Heat retainer
60: Roll press
P: Positive electrode sheet
N: Negative electrode sheet
B: Battery member

What is claimed is:

1. A method for producing a battery member having a positive electrode sheet including at least a positive electrode current collector and a negative electrode sheet including at least a negative electrode current collector, at least one of the positive electrode sheet and the negative electrode sheet having an electrolyte layer laminated thereon, the method comprising successively:
a preliminary heating step including heating the positive electrode sheet and the negative electrode sheet to a predetermined temperature; and
a roll pressing step including integrating the positive electrode sheet with the negative electrode sheet, wherein
in the roll pressing step, a roll pressing temperature for the positive electrode sheet and a roll pressing temperature for the negative electrode sheet are set to different temperature ranges.

2. The method according to claim 1, further comprising:
after the roll pressing step, a stepwise cooling step including cooling in a stepwise manner the positive electrode sheet and the negative electrode sheet that have been integrated with each other.

3. The method according to claim 1, wherein in the preliminary heating step, a preliminary heating temperature for the positive electrode sheet and a preliminary heating temperature for the negative electrode sheet are set to different temperature ranges.

4. A device for producing a battery member having a positive electrode sheet including at least a positive electrode current collector and a negative electrode sheet including at least a negative electrode current collector, at least one of the positive electrode sheet and the negative electrode sheet having an electrolyte layer laminated thereon, the device comprising:
a first heater that heats the positive electrode sheet;
a second heater that heats the negative electrode sheet; and
a roll press that is disposed after the first heater and the second heater, and that integrates the positive electrode sheet with the negative electrode sheet, wherein
in the roll press, a heating temperature for the positive electrode sheet and a heating temperature for the negative electrode sheet are set to different temperature ranges.

5. The device according to claim 4, further comprising:
a heat retainer disposed after the roll press.

6. The device according to claim 4, wherein a temperature of the first heater and a temperature of the second heater are set to different temperature ranges.
